(19) United States
(12) Patent Application Publication
(10) Pub. No.: US 2006/0111092 A1
(43) Pub. Date: May 25, 2006

(54) Alert management apparatus and method

(76) Inventors: Doug S. Harris, Arlington, TX (US); Craig M. Templin, Grandbury, TX (US)

Correspondence Address: SIDLEY AUSTIN LLP, 717 NORTH HARWOOD, SUITE 3400, DALLAS, TX, 75201, US

(21) Appl. No.: 10/995,990

(22) Filed: Nov. 23, 2004

(51) Int. Cl. H04M 3/00

(52) U.S. Cl. 455/418

(57) ABSTRACT

An alert management system (AMS) can initiate, process, and monitor an alert cycle. The AMS can initiate a predefined alert based on an initiation command or based on a comparison of data to predefined alert initiation rules. The AMS can select individuals to contact and/or plans for contacting each individual based on the context of the alert. The AMS allows individuals to request notification for certain alerts and/or for specific transitions within a cycle of the alert. When a user is notified, they can provide feedback confirming receipt of the notification and/or request initiation one or more additional predefined alerts. Users can also provide a backup contact person that the AMS should contact if the user cannot be reached. The AMS provides users with progress information, which can include an indication of who has received notification of the alert in progress.

### FIELD OF THE INVENTION

This invention relates to an apparatus and method for automated processing of an alert. More specifically, the invention relates to an apparatus and method for alert initiation, monitoring, and notification.

### BACKGROUND

There are many different situations that can arise where a group or organization wants to disseminate specific information in response to a certain event. In some cases, the event can be an emergency situation, while in other cases the event might be less urgent or not urgent at all. Examples of such events can vary from one group or organization to another, and can include such things as system failures, power outages, pipeline leaks, and severe weather, as well as other things such as a change in market conditions, a shortage of inventory, or a club outing. Whenever such an event occurs, a procedure of some kind is usually followed for notifying appropriate personnel of the event so that any necessary action can be taken. This procedure can be referred to as an alert procedure.

In some cases, the alert procedure is a manual process where a person places phone calls to each member of a contact list. This type of procedure is inefficient in that the issuance of the alert information is delayed for individuals that are not near the top of the contact list. This type of procedure is also inefficient for situations where a contact list is rather extensive since a significant amount of time and/or people are required for making all of the telephone calls necessary to contact everyone on the contact list. Worse yet, confusion and uncertainty can sometimes arise when several people are involved in issuing alert notifications for an extensive contact list since it can be difficult under such circumstances to keep track how the list has been divided among all of the people issuing the alert notifications.

In other cases, a person might be able to send out a broadcast message, which is a single message sent somewhat simultaneously to each member of a contact list, for example through the use of pagers. This type of alert procedure is advantageous in that there is no delay in contacting individuals lower on the list while attempts are being made to contact individuals higher on the list. On the other hand, this procedure provides limited accountability since no immediate feedback is provided as to whether individuals actually received the broadcast alert message. There may also be situations where issuing broadcast alert notifications is not always convenient, such as situations where a list of people needing to be contacted changes depending on the details of the event so that predefined contact lists are not practical. For example, a school wanting to send an alert notification to parents of absent students would need to compile a different list each day.

### SUMMARY OF THE INVENTION

In view of the shortcomings discussed above, the present invention provides a system for automating alert notification procedures in order to provide improved efficiency and overall accountability of an alert process.

In accordance with one aspect of the present invention, an alert management system is provided that can detect an initiation of an alert according to a predefined alert definition that includes first and second status conditions and a first-transition subscriber that subscribes to a transition between the first and second status conditions, transition the alert from the first status condition to the second status condition, and attempt to deliver a notification of the transition from first to second status condition to the first-transition subscriber according to a contact plan associated with the first-transition subscriber.

The alert management system can provide a progress report indicating whether the first-transition subscriber has received the notification.

The predefined alert definition can include an alert workflow stipulating that the alert includes a plurality of status conditions including a first and second status condition. The plurality of predefined status conditions can include at least one of a pending status condition, an active status condition, and a cancelled status condition.

The alert management system can retrieve context information related to the initiation of the alert. The context information can include such things as a time of alert initiation, an alert-initiating user, a severity, a location, a priority, a message, and/or an expiration time.

The alert management system can attempt to deliver the notification according to a selected one of a plurality of contact plans associated with the first-transition subscriber. Each contact plan can include one or more methods of contacting the first-transition subscriber. The contact plan can be selected based on the retrieved context information. The alert management system can attempt to deliver the notification by attempting to contact the first-transition subscriber using each of the one or more methods included in the contact plan in a predetermined order until the notification has been delivered.

The alert management system can request a transition confirmation for transitioning the alert from the first status condition to the second status condition. The alert management system can be configured to transition the alert from the first status condition to the second status condition only if the transition confirmation is received.

If a predetermined point in the contact plan is reached, attempts to contact the first-transition subscriber can be halted and the alert management system can proceed to attempt to contact an escalation user designated by the contact plan. The alert management system can also request confirmation feedback confirming that the first-transition subscriber has received the notification.

During notification, the alert management system can provide a subscriber with the opportunity to initiate another alert. For example, the system can request whether the first-transition subscriber would like to initiate another alert.

According to another aspect of the present invention, an alert management system is provided that can detect an initiation of an alert according to a predefined alert definition that includes a designated subscriber, retrieve context information related to the initiation of the alert, determine whether the designated subscriber should be notified of the alert based on the retrieved context information, and attempt to deliver a notification of the alert to the designated subscriber only if it is determined that the designated subscriber should be notified. The context information can include at least one of a time of alert initiation, an alert-initiating user, a severity, a location, a priority, a message, and an expiration time. The alert management system can also select one of a plurality of contact plans for contacting the designated subscriber based on the retrieved context information.

According to another aspect of the present invention, an alert management system is provided that can detect an initiation of the alert according to a predefined alert definition that includes a designated subscriber, retrieve context information related to the initiation of the alert, select one of a plurality of contact plans for contacting the designated subscriber based on the retrieved context information, and attempt to deliver a notification of the alert to the designated subscriber based on the selected contact plan. Each of the plurality of contact plans can include one or more methods of contacting the designated subscriber. The alert management system can attempt to contact the designated subscriber using each of the one or more methods included in the selected contact plan in a predetermined order until the notification has been delivered.

### BRIEF DESCRIPTION OF THE DRAWINGS

The present invention is illustrated by way of example and is not limited in by the figures of the accompanying drawings, in which like reference numbers indicate similar parts:

FIG. 1 shows a block diagram of a system architecture associated with an embodiment of an alert management system of the present invention;

FIG. 2 shows a more detailed block diagram of the architecture shown in FIG. 1;

FIG. 3A shows a schematic diagram of elements of or associated with an embodiment of an alert definition;

FIG. 3B-3D show schematic diagrams of exemplary alert status conditions;

FIG. 4 shows a flowchart depicting an embodiment of a workflow process for an alert;

FIGS. 5A-5D show schematic diagrams of exemplary elements of user information used by an embodiment of the alert management system;

FIG. 6 shows a flowchart depicting an embodiment of a process for executing a contact plan;

FIG. 7 shows a flowchart depicting an embodiment of a process for executing a contact method; and

FIG. 8 shows an exemplary graphical user interface that can be used to monitor progress of an ongoing alert.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein.

The present invention is directed to a system, including apparatus and method, for alert management, termed herein as an alert management system (AMS). In one embodiment, the AMS is a web service provided on a server accessible via the Internet and an organization can become an AMS customer by establishing an account with the AMS using a web-based graphical user interface (“GUI”). However, it should be noted that while the present invention is being described within the context of a business-customer relationship, this is not intended to impose any sort of limitations on the present invention. An AMS customer can specify a list of users having various levels of administrative rights to manage the account. The AMS customer can designate certain users as administrative users who can provide alert information to the AMS. The alert information can include alert definitions and personnel contact lists listing personnel to contact if an alert is initiated. The AMS can store the alert definitions in a database, detect an instance of an alert initiation, and deliver alert notifications to personnel on the alert's contact list. The AMS can notify personnel of the pending alert using a variety of different communication platforms, such as telephone, pager, fax, and email, and request confirmation feedback from the notified personnel. The AMS provides an alert monitor screen as part of the GUI that allows the AMS customer to monitor an alert in progress. The AMS can escalate an alert based on feedback received during an alert notification and/or based on the alert progress according to the alert definition.

System Architecture

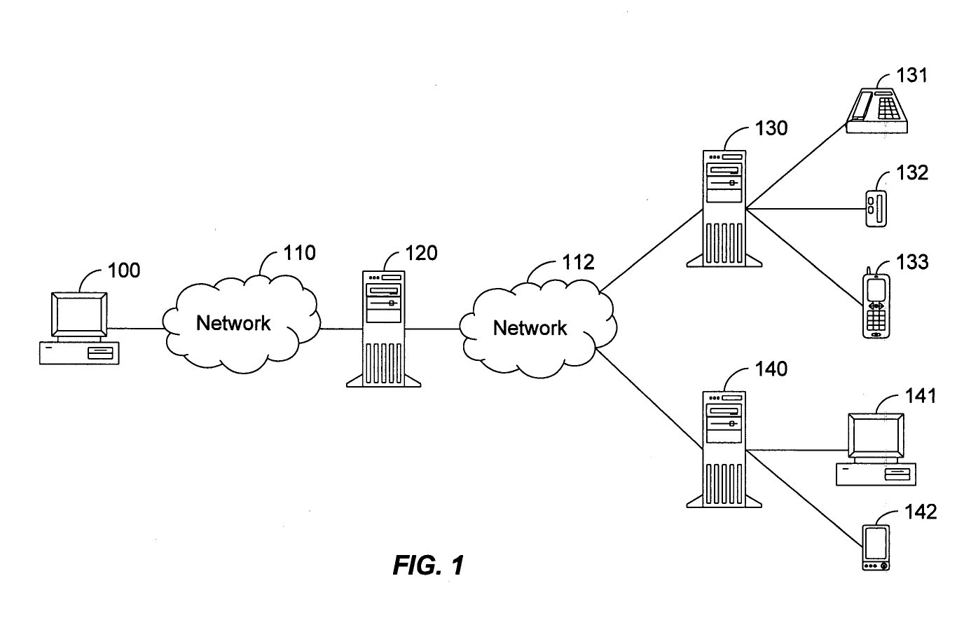

Referring to FIG. 1, illustrative architecture suitable for implementing the AMS and methods of the present invention is described. In FIG. 1, this architecture comprises a personal computer 100 coupled through a network 110 to an alert server 120. The network 110 can be any kind of network, can include wired or wireless couplings, and can include an open network such as the Internet. The alert server 120 is, in turn, coupled through a network 112 to a voice server 130 and a mail server 140. The network 112 can also be any kind of network, can include wired or wireless couplings, and can include an open network such as the Internet. The voice server 130 provides a web service for communicating with a variety of communication devices, for example a telephone 131, a pager 132, and a cellular telephone 133. The mail server 140 communicates electronic messages, such as email, to a variety of devices, for example a personal computer 141 and a personal digital assistant (“PDA”) 142.

The personal computer 100 represents one or more computers and/or servers accessible by an AMS customer. The personal computer 100 preferably includes a web browser, such as Internet Explorer® or Netscape Navigator®. The personal computer 100 may be an IBM personal computer (or any other type or make of computer), or take the form of other devices capable of establishing a connection to the network 110, including television set-top boxes, handheld devices, Personal Digital Assistants (PDAs) or cellular telephones.

The alert server 120 is programmed with Alert Management System (“AMS”) software constructed in accordance with the present invention. The alert server 120 can interact with a user at the personal computer 100 through a GUI in a web browser. In a preferred embodiment the GUI is generated using the Macromedia trademark “FLASH” standard or the substantial equivalent thereof.

The voice server 130 and mail server 140 are server computers programmed with web service software for providing a web service that relays communications. The alert server 120 can communicate with the voice server 130 using a standardized XML (Extensible Markup Language) messaging system, such as VoiceXML, that preferably complies with well-known Web Services standards established by the World Wide Web Consortium (W3C). The alert server 120 can communicate with the mail server 140 using known Internet standards for electronic messaging such as POP3 and SMTP. The voice server 130 provides a web service for relaying communications to communication devices, for example the telephone 131, pager 132, and cellular phone 133 in accordance with instructions received from the alert server. Voice recognition software can be employed for input to the system. In the case of the mail server 140, a web service is provided for relaying communications in the form of an email to devices capable of exchanging email, for example the personal computer 141 and the PDA 142. It will be appreciated by those skilled in the art that any number of web services can be used for relaying information in any form to any type of communication equipment.

Web Services standard XML can be used to encode all communications between the personal computer 100, the alert server 120, and the voice and email servers 130 and 140. By providing all communication in a standardized XML format, integration of the AMS system with systems on the user's end as well as web services software on the voice and email servers 130 and 140 is simplified, for example software on the various computers and servers can be implemented with any operating system or programming language. The web services available at the various servers can have a public interface, defined in a common XML grammar. The interface describes all the methods available and specifies the signature for each method. The interface definition can be accomplished via the Web Service Description Language (WSDL).

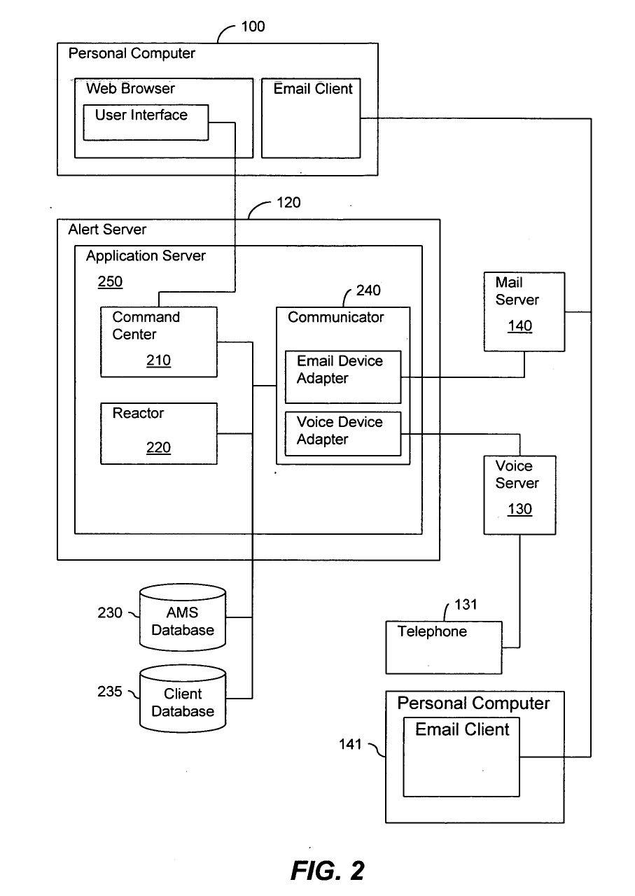

FIG. 2 shows a more detailed block diagram of an embodiment of the AMS system. It will be appreciated that there are many ways of arranging and configuring various components and systems other than the specific arrangement shown in FIG. 2 without departing from the spirit and scope of the present invention. In the embodiment shown in FIG. 2, the AMS system is embodied as software applications stored on a computer-readable storage medium on or accessible by the alert server 120. The software applications include a command center 210, a reactor 220, and a communicator 240. It will be appreciated that these applications can be combined into fewer software applications, even a single software application, or can be divided into any number of software applications without departing from the spirit and scope of the present invention. It will also be appreciated that some or all of the AMS system can be provided in forms other than software applications. The AMS system also includes an AMS database 230 for storing alert and user information. Some of this information can be stored remotely, for example on a client database 235 that is maintained by the AMS customer. The code for each of the command center 210, the reactor 220, and the communicator 240 is preferably written using the Java programming language and supports the Java 2 Enterprise Edition (J2EE) technology from Sun Microsystems Inc. of Mountain View, Calif. The command center 210, the reactor 220, and the communicator 240 preferably operate in conjunction with an application server 250, such as Web Logic from BEA Systems, Inc. Communication between the command center 210, the reactor 220, and the communicator 240 preferably is performed according to the aforementioned Web Services XML standards.

The AMS database 230 can be local to the AMS server 120 or reside on a separate database server or database management system (DBMS). The database 230 is preferably an SQL database, such as an Oracle database, but any kind of database can be used. The command center 210, the reactor 220, the database 230, and the communicator 240 components of the AMS can reside locally on the alert server 120. On the other hand, as would be appreciated by one skilled in the art, components of the AMS can be distributed among any number of computers or servers.

The command center 210 is an interfacing component of the AMS responsible for interfacing with users in order to facilitate alert preparation and follow-up. It is the central, administrative command and control point of the AMS. The command center 210 provides an AMS customer with a GUI that allows an administrative user at the personal computer 100 to manage an alert lifecycle and define, monitor, manage and optimize alerts. The GUI provided by the command center 210 includes database maintenance screens for populating tables in the database 230 subsequently to be used by the reactor 220 to know how to handle an alert. The GUI also includes an alert monitoring screen that allows for management and monitoring, preferably in real time, of every alert and every notification of every alert. The command center 210 can also provide for encrypted communication between the personal computer 100 and the alert server 120, for example using the Secure Sockets Layer (“SSL”) communications protocol.

The reactor 220 is a processing component of the AMS responsible for automated handling of an alert once it has been defined by a user through the command center 210. The reactor 220 manages the life cycle of an alert, provides context matching of events with subscribers, triggers the communicator 240 to perform notification, and executes contact plans that define what order and steps to go through at the time of an alert. The alert definition tells the reactor 220 who needs to be contacted about what, how to contact them and when they need to be contacted. The reactor 220 can also use the alert definition to determine that, if it is unable to contact an intended recipient on a given device, it should attempt to contact them on a different device. The reactor 220 also can determine when to try to contact a different recipient if the first recipient cannot be contacted. Finally, the reactor 220 keeps track of every contact attempt, including tracking who has responded to a contact attempt and who has not.

The communicator 240 is a communications component of the AMS responsible for the distribution and delivery of alert notifications. The communicator 240 is the integration point for all of the different ways to notify someone. The communicator 240 is invoked by the reactor 220 and includes communication portals or adapters for communicating with messaging web services, such as the ones described above provided by the voice and email servers 130 and 140.

Alert Definitions

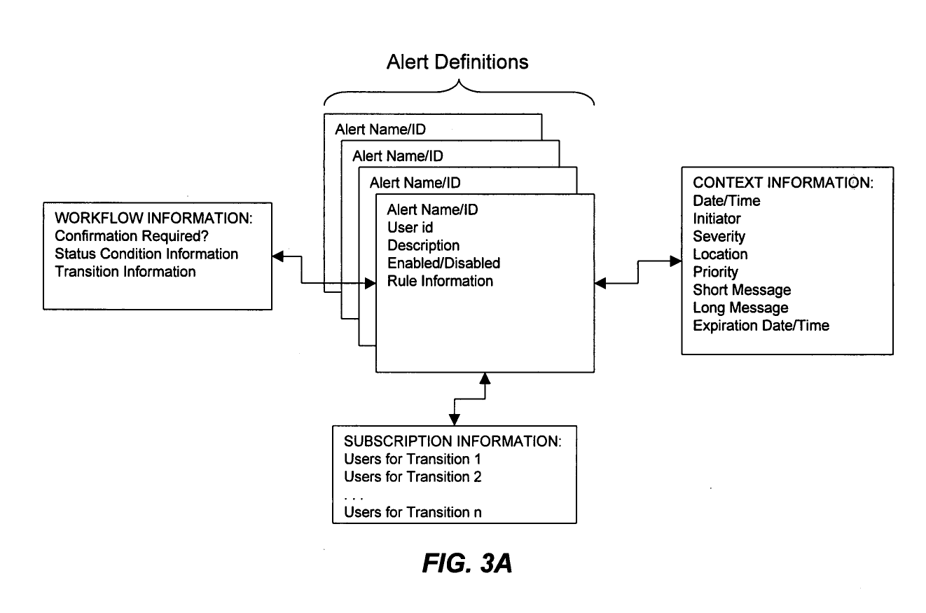

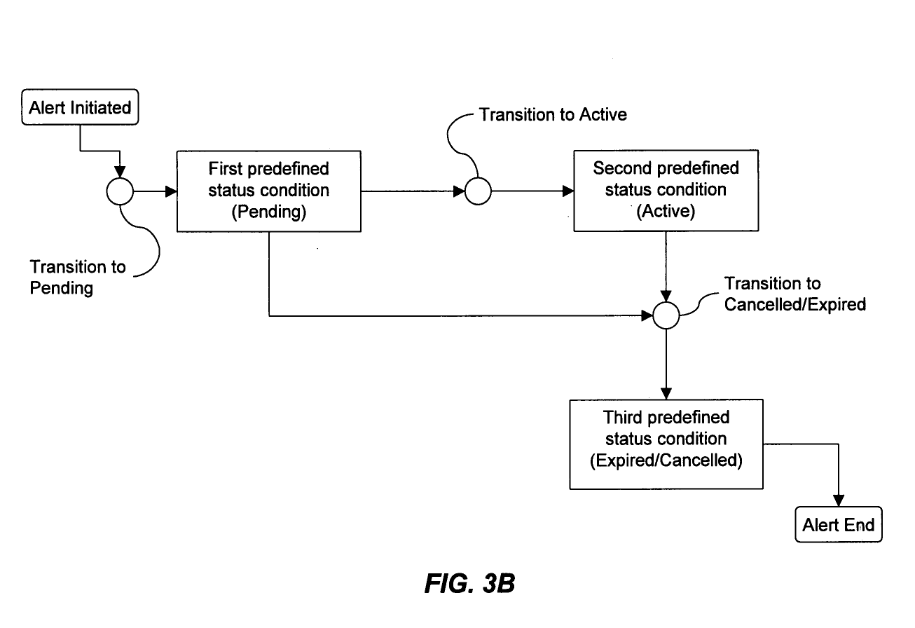

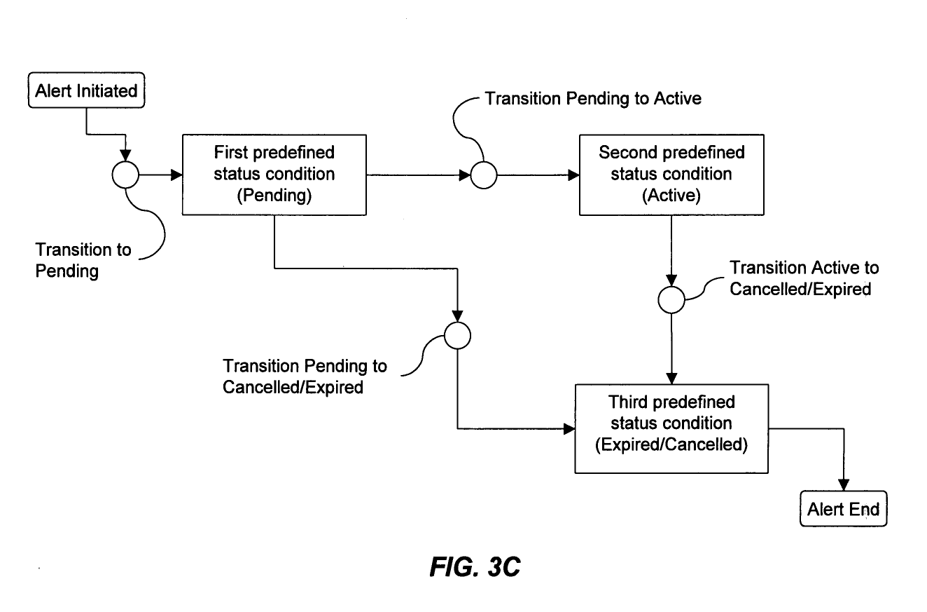

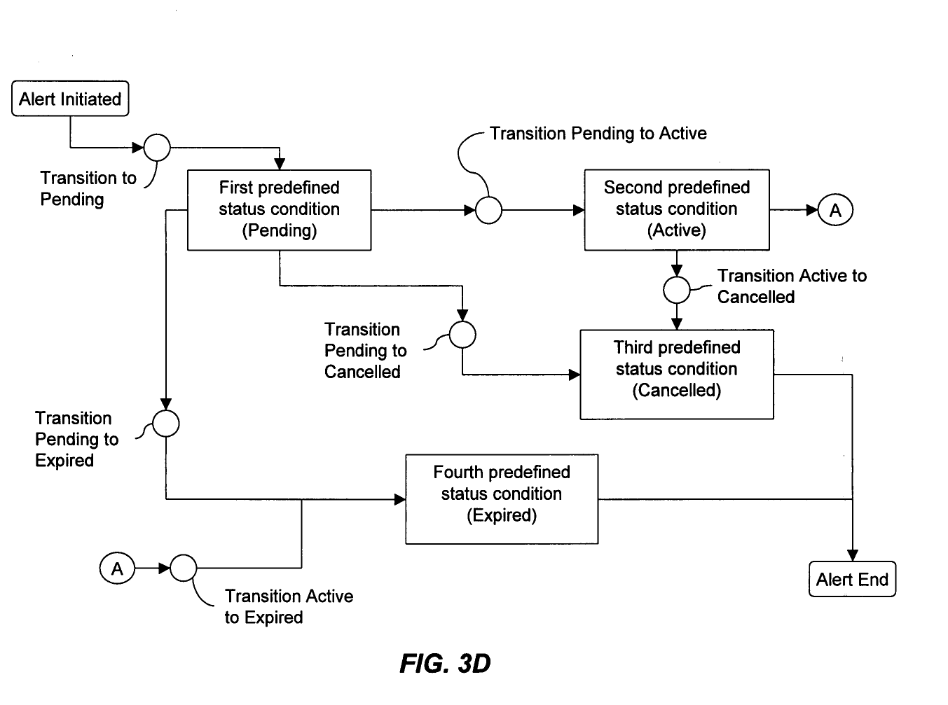

An exemplary alert definition is shown in FIG. 3A. In the present embodiment, an alert definition includes such information as a unique alert definition identifier or name, a unique user (e.g., AMS customer) identifier, a description, and an enabled/disabled indicator. Administrative users can use the GUI provided by the AMS to create one or more alert definitions, and users can use the GUI provided by the AMS to subscribe to one or more of the alert definitions.

For example, a certain AMS customer might be a building management company that defines a first alert for water leaks and a second alert for power outages. Maintenance personnel responsible for repairing water leaks can be subscribed to the water leak alert, while other maintenance personnel responsible for repairing power outages are subscribed to the power outage alert. A maintenance supervisor responsible for the plumbing and electrical personnel might be subscribed to both alerts.

Each alert definition includes, or is associated with, additional information that can include subscription information, workflow information, and context information, each of which will now be discussed in greater detail.

The subscription information tells the AMS which users are subscribed to a particular alert and therefore should be contacted. In a preferred embodiment, the AMS allows users to subscribe not only to alerts, but also to “transitions” occurring during an alert. For example, as shown in FIG. 3B, a particular alert might include a plurality of predefined status conditions and predefined transitions therebetween. The predefined status conditions include a first predefined status condition that can be a pending status condition, a second predefined status condition that can be an active status condition, and a third predefined status condition that can be a cancelled/expired status condition. In this example, the first, second, and third status conditions can occur consecutively, or the first and third status conditions can occur consecutively without an instance of the second status condition. In the case shown in FIG. 3B, a first predefined transition occurs when an alert is initiated and transitions to a pending status condition, a second predefined transition occurs when the alert is confirmed and transitions from pending to active status condition, and a third transition occurs when the alert transitions from either pending or active to cancelled/expired status condition. Users can subscribe to one or more of the first, second, and third transitions so that they are notified if the transition occurs during an instance of the alert.

It will be appreciated that an alert definition can include any number of status conditions and transitions. For example, FIG. 3C shows a case where the alert includes the same status conditions as the case in FIG. 3B, but includes a greater number of transitions. Specifically, the example shown in FIG. 3C includes an additional transition for transitioning from pending to cancelled/expired status condition. This example allows for a finer level of detail, allowing subscribers to specify not only what status condition the alert is transitioning to, but also what status condition the alert is transitioning from.

FIG. 3D shows yet another example having a still finer level of detail in terms of status conditions and transitions. In this example, “cancelled” and “expired” are separate status conditions and additional transitions are available to accommodate the additional status conditions.

Advantages of allowing users to subscribe to transitions rather than just the alert itself can be appreciated considering, as an example, the above-described case of the building maintenance company and the water leak alert having transitions and status conditions as shown in FIG. 3C. A sensing device (not shown) that is used for detecting a water leak might be configured to transmit a signal indicative of a water leak to the AMS. It will be appreciated that such a sensing device can be coupled to provide data for the AMS in many different ways. For example, the sensor can be coupled directly to the AMS, can be coupled to the AMS over a network, or can be coupled to the personal computer 100 or the client database 235 for relaying data from the sensor to the AMS. For example, the client computer 100 can periodically sample data from the sensor and store the sampled data in the database 235, and the AMS periodically can input the data from the database 235. The AMS can determine that an alert definition exists in the AMS database for the water leak signal and, based on data generated by the sensor, can initiate the water leak alert in a pending status condition. Alternately, the client computer 100 can monitor the sensor or data from the sensor and, if necessary, send an instruction to the AMS to initiate the water leak alert.

In any case, building security personnel might be first-transition subscribers subscribed to “Transition to Pending” so that the security personnel can perform a visual inspection to verify whether there is actually a water leak. Thus, the AMS notifies the subscribed security personnel of the pending alert. If upon visual inspection the security personnel verify the existence of a leak (for example as opposed to a faulty leak sensor) then the security personnel can access the AMS, for example via the AMS GUI, and confirm the need to activate the leak alert. Upon confirmation of the leak alert, the AMS transitions the alert from “Pending” to “Active”. The appropriate maintenance personnel could be second-transition subscribers who are subscribed to “Transition Pending to Active” so that they are contacted when necessary to make an emergency repair. Once sufficient personnel are contacted, a user monitoring the alert can instruct the AMS to transition the alert to Expired/Cancelled. The maintenance supervisors could be third-transition subscribers who are subscribed to “Transition Active to Cancelled/Expired” so that they are notified when sufficient personnel have been contacted. The maintenance supervisors can additionally be subscribed to “Transition to Pending” and/or “Transition Pending to Active” allowing them to be notified at several transitions during the alert.

If it is determined that there is no actual leak, the security personnel can instruct the AMS to cancel the alert, so that the AMS transitions the alert directly from “Pending” to “Cancelled/Expired”. The maintenance supervisors could further be fourth-transition subscribers who are subscribed to “Transition Pending to Cancelled/Expired” so that they are notified when an alert can be cancelled without being activated. In this case, the maintenance supervisor might want to initiate a separate alert to have a faulty leak sensor replaced.

Thus, in the above-described example, a water leak alert would include or be associated with subscription information that designates certain security personnel as being subscribed to “Transition to Pending”, the maintenance personnel as being subscribed to “Transition Pending to Active”, and the maintenance supervisor as being subscribed to “Transition to Pending”, “Transition Pending to Active”, “Transition Pending to Cancelled/Expired”, and “Transition Active to Cancelled/Expired”. By allowing users to subscribe to transitions within an alert rather than just subscribing to the alert itself, unnecessary notifications can be avoided. Considering the above example, since maintenance personnel can subscribe to the transition to active status condition rather than to the alert as a whole, they can avoid being contacted unless there is a confirmed need for a repair.

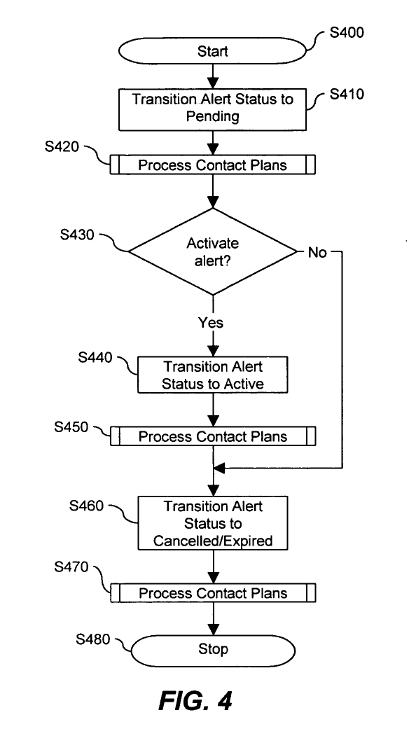

Alert workflow information tells the AMS what steps to take in processing the alert. A flowchart shown in FIG. 4 illustrates an exemplary alert workflow. Upon initiation of an alert at step S400, the process proceeds to step S410 where the alert status condition transitions to “pending” and then to step S420 where an attempt is made to contact users subscribed to the transition to pending. At step S430, an alert confirmation request is issued. An alert confirmation request can be issued via the GUI at the AMS customer's computer 100, or it can be issued via a contact plan (discussed in greater detail below) to one or more predetermined users, such as one or more of the users subscribed to the transition to pending. In any case, the AMS attempts to confirm that the particular AMS customer desires to allow the initiated alert to be fully activated. If confirmation is received that the AMS customer wants to proceed with activation of the alert, then the process continues to step S440 where the alert transitions from “pending” to “active”. The process then continues to step S450 where an attempt is made to contact users subscribed to the transition to active. Upon completion of the contact plans, the process continues to step S460 where the alert transitions to a cancelled or expired status condition, and then to step S470 where an attempt is made to contact users subscribed to the transition to cancelled or expired.

It will be noted that, at step S430, a user can instruct the AMS to cancel the alert, in which case the process continues to step S460. Alternatively, it is possible that the AMS is unable to receive any instructions at step S430. In this case, the alert definition can include a default condition where the AMS is to activate or cancel the alert in cases where confirmation cannot be received. The alert definition can also include a time limit for step S430, limiting the amount of time the AMS spends attempting to receive confirmation, and instructing the AMS to proceed with activation or cancellation of the alert if time expires before step S430 is completed.

It should also be noted that it is not necessary for an alert definition to include a confirmation step. As indicated in FIG. 3A, the workflow information can include an indication as to whether the alert requires confirmation. Thus, an alert definition can be established that, upon initiation, is automatically activated without confirmation of any kind. In this case, there would be no transition to pending that a user could subscribe to, so steps S410, S420, and S430 could be omitted.

It should further be noted that the context information (discussed below) can include expiration constraints for the alert process. At various points in the workflow process, the AMS could check to see if the alert has expired, for example due to a predefined amount of time elapsing or arrival at a predetermined expiration date and time.

Context information is collected by the AMS upon initiation of an alert. Context information provides information related to a set of circumstances or conditions of the initiated alert. Thus, it is contemplated that there are many more types of information that can be included as context information than can be practically listed here. However, an exemplary embodiment shown in FIG. 3A of context information includes a date and time of alert initiation, an initiating user (if the alert was manually initiated by a user), the severity of the situation, a location of the situation, a priority (e.g., relative to other active or pending alerts), a short message that can be displayed on the AMS monitor screen related to the nature of the alert, a longer message for email, text, or text-to-voice messaging delivery to users as part of the alert notification, and an expiration date and time for the alert.

The context information can be collected by the AMS in different ways depending of the nature of the information. For example, the AMS can determine initiation date and time from a system clock, and can determine initiating user from login information if the user was required to login to the system in order to initiate the alert. The AMS can also collect the information through the GUI, which provides users with an alert initiation screen for collecting the context information.

The context information can be used by the AMS to make intelligent decisions during the alert process based on predefined rules in the alert definition. For example, as discussed in greater detail below, subscribing users can establish multiple contact plans each outlining a different way in which the user should be contacted. Each contact plan can be associated with different parameters, for example a user might have one contact plan for weekdays and a second contact plan for evenings and weekends. The reactor 220 can then select a contact plan based on the initiation time and date. Thus, the way in which a user is contacted can depend on the context of the alert.

An alert definition can include rules for the reactor 220 to apply context information in order to decide whether a user or users should be contacted. Thus, a subscribing user can stipulate that they only want to be contacted if certain conditions of the alert exist. For example, consider a case where a certain AMS customer is a chess club, and a particular alert definition named “upcoming tournament” is for contacting members of the chess club to notify them of upcoming tournaments. Context information for the “upcoming tournament” alert can include a date and time of the tournament that members are being notified about. In this case, members of the chess club can subscribe to the “upcoming tournament alert”, and can stipulate, for example, that only want to be contacted if the tournament is on a weekend.

Other information associated or included with an alert definition can relate to how the alert can be initiated. Alerts can be initiated manually, for example by a user accessing the AMS via the GUI and instructing the AMS to initiate an alert. In this case, it is possible that initiating user can also provide the aforementioned activation confirmation in conjunction with the alert initiation process.

Alerts can also be initiated automatically. One way this is accomplished is by providing the alert definition with initiation rules, where the reactor 220 compares some data to the initiation rules and makes a determination as to whether the alert should be initiated. In the example above, data from a leak sensor is received by the reactor 220, compared to initiation rules for the leak alert, and the reactor 220 initiates the leak alert if appropriate.

As another example, an AMS customer can establish an alert definition catalog and an associated set of alert initiation rules. In this case, the reactor 220 could sample some data received from the AMS customer, process the data using the alert initiation rules, and depending on the result of the rule processing, the reactor 220 could initiate one or more alerts in the AMS customer's alert definition catalog.

The data the reactor 220 uses for processing the alert initiation rules can come from any source, for example security or equipment sensors. However, it is contemplated that there are endless possibilities for the types and sources of data used for initiation rule processing. This is particularly true for the present embodiment where, as mentioned above, the reactor 220 can communicate with other programs using a standard web services XML protocol. Thus, the reactor 220 can receive (or retrieve) data from any program integrated with Web Services XML running on any computer networked in any way to the alert server 120. For example, the AMS customer can have a Microsoft® Excel spreadsheet integrated with Web Services XML that is automatically updated with information received from a number of warehouse and retailer computers to reflect inventory results. The reactor 220 in turn receives (or retrieves) data from the spreadsheet, applies the data to alert initiation rules, and determines whether any alert should be initiated. In this case, the AMS customer can set up rules for alerting a manufacturing facility when an inventory falls below a certain threshold. If the reactor 220 determines based on rule processing that the inventory is below the certain threshold, the reactor can automatically initiate the appropriate alert.

As an alternative to the AMS customer setting the alert initiation rules, a sender may similarly establish alert initiation rules, thereby allowing the sender to target customers. As an example, an attribute can be included in the user record entitled “region,” and correspond to where the AMS customer resides. The sender can then establish an alert initiation rule such that all AMS customers with a “region” attribute of “southwest” will be notified when the sender sends an alert with a “region” value of “southwest.”

In summary, two methods exist for determining which AMS customer will receive what alert: subscription (the AMS customer sets the alert rules) and targeting (the sender sets the alert rules). Further, the methods can be either dynamic or static. A static subscription results when the AMS customer specifies the rule prior to an alert being issued, i.e., the AMS customer desires to be notified regarding a specific alert. In contrast, a dynamic subscription is based upon attributes associated with both the alert and the AMS customer. By specifying the attributes, the AMS customer “finds” the alert via the reactor 220 and its ability to match the AMS customer specified attributes and the attributes specified by the alert's sender. Thus, whether the AMS customer receives an alert is determined when the alert is actually being sent. Static targeting, similar to a static subscription, is established by rules specified by the sender prior to sending the alert. Dynamic targeting allows the sender to establish a rule within the alert. The alert then “finds” all relevant AMS customers based upon the reactor 220 which matches the attributes specified in the sender's rule and the AMS customer's attributes.

User Data

As mentioned above, a user can define an alert using the AMS browser-based GUI provided by the command center 210. As an initial step, user information can be imported, for example from the client database 235 to the AMS database 230, or manually input by a user or users via the GUI. Thus user information can be stored in the AMS database 230, a client database 235, or a combination of the two or more databases.

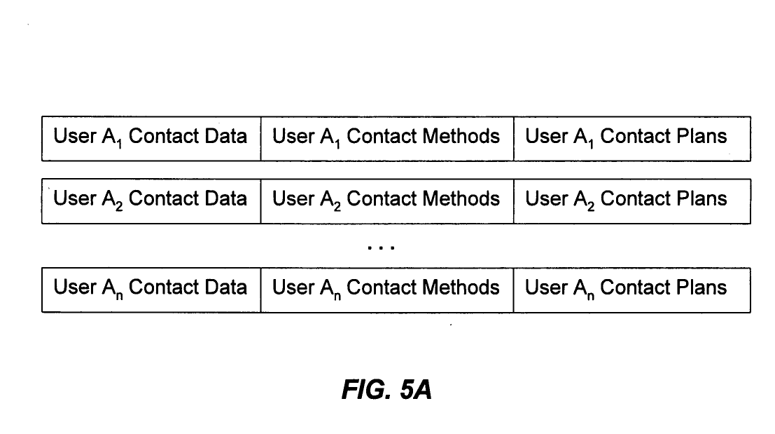

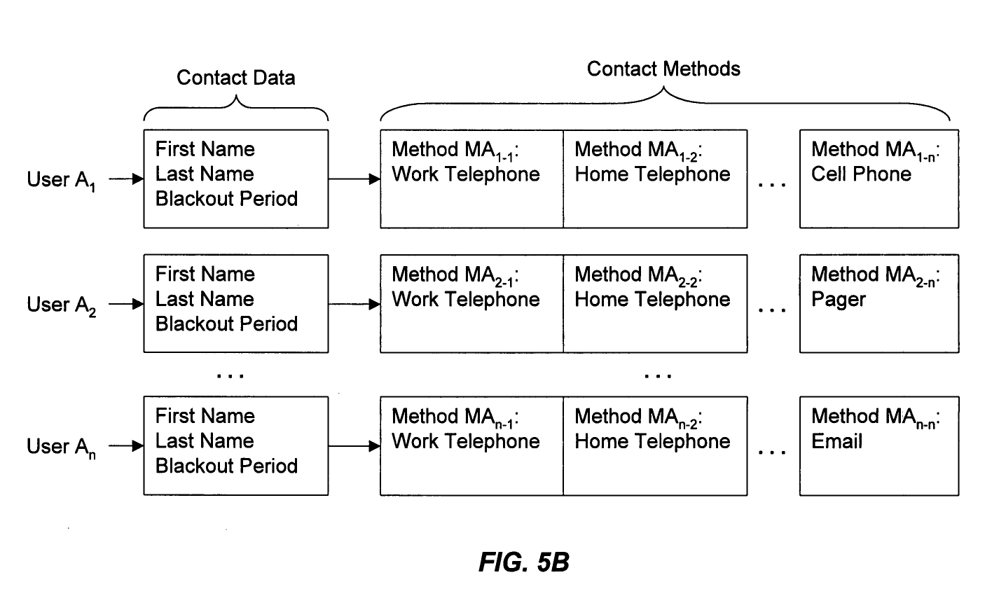

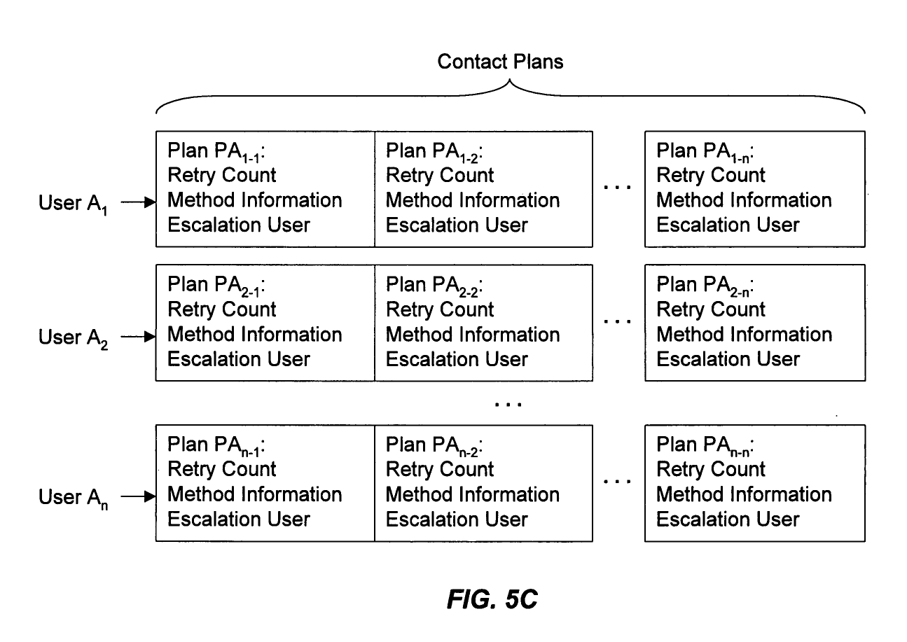

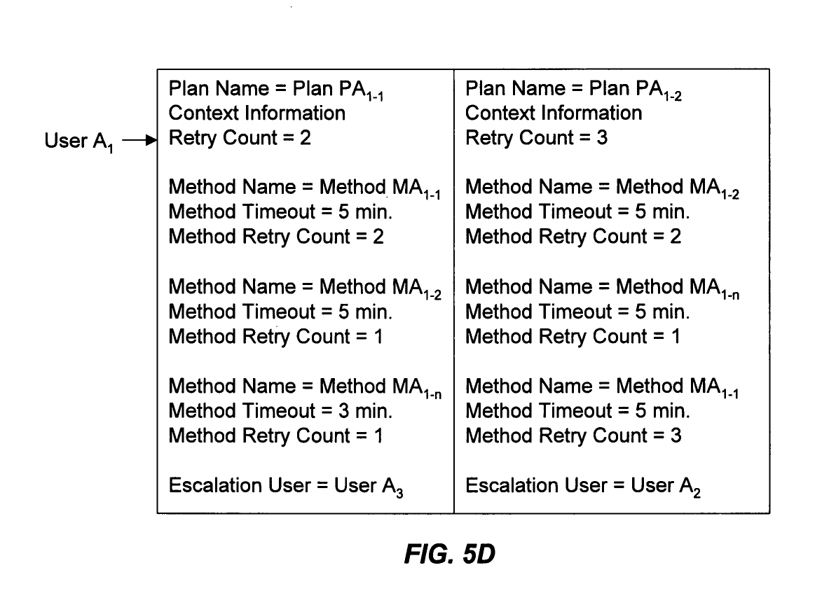

As shown in FIG. 5A, the user information stored in database 230 includes contact data, contact methods, and contact plans for each of users A₁ through Aₙ. It should be noted that “n” is used throughout this document to indicate a numeric value that can be any value.

FIG. 5B shows a more detailed view of the contact data and contact methods. The contact data is general profile information for the user, which in the exemplary embodiment includes the user's name as well as blackout period information. The blackout period information can be used to specify date and/or time ranges for which notification to that particular user should be immediately escalated to the user's first level escalation contacts (discussed below). The contact data can further include any other desired profile information, such as an address, AMS system login information (e.g., a username and password), and an indicator as to whether the user's account is enabled or disabled.

FIG. 5B also shows examples of contact methods. Contact methods are ways in which the associated user can be contacted. Each contact method includes a unique contact method name (e.g., “Method MA₁₋₁”), a type of communication and any necessary connection data associated with or necessary for that communication. For example, in the exemplary embodiment shown in FIG. 5B, User A₁ can be contacted by several different methods including a work telephone (Method MA₁₋₁), a home telephone (Method MA₁₋₂), and a cellular telephone (Method MA₁₋ₙ). Again, it should be noted that “n” is used throughout this document to indicate a numeric value that can be any value, and it should be further noted that throughout this document a specific value for “n” can vary from one instance to another (e.g., the use of “n” in both “Aₙ” and “MA₁₋ₙ” is not intended to imply any relationship between the total number of users and the number of methods for a user). Considering Method MA₁₋₁ as an example, the Method MA₁₋₁ data includes an indicator that the type of communication for Method MA₁₋₁ is a telephone as well as the associated telephone number. As another example, User Aₙ can be contacted by several different methods including email (Method MAₙ₋ₙ). In this case, the Method MAₙ₋ₙ data includes an indicator that the type of communication for Method MAₙ₋ₙ is email as well as the associated email address. It will be appreciated that there are several ways to implement the organization or storage of this information in a database to allow for association between a types of communication and connection data.

Turning now to FIGS. 5C and 5D, contact plans will be discussed. A contact plan provides information as to what contact methods should be used to contact a specific user, what order the contact methods should be attempted, under what circumstances (i.e., context data) the particular contact plan should be used, and when the notification should be escalated to a different user. As mentioned above, when an alert occurs the AMS system will attempt to contact users that are subscribed to the alert. The AMS system attempts to contact users via one or more different types of communication according to contact plans. The AMS can determine which contact plan to use based on context information. In the exemplary embodiment, the AMS attempts to contact each user via one type of communication at a time, working its way through a list of contact methods in a contact plan until the user has been contacted.

As shown in FIG. 5C several contact plans have been set up for Users A₁, A₂, and Aₙ. Contact plans for a user can vary based on context information, such as where or when the alert occurs. For example, if the alert occurs during the day on a weekday, it might be best to first attempt to contact a user at their work telephone, whereas if the alert occurs in the evening or on a weekend, it might be best to first attempt to contact that user at their home telephone. On the other hand, this might not be true for a second user that works an evening shift. As another example, a user can have a contact plan to be used for low-severity alerts and another contact plan to be used for high-severity alerts. Thus, the AMS system allows for one or more custom contact plans to be set up for each user.

In the exemplary embodiment, contact plans for User A₁ include contact plans PA₁₋₁ and PA₁₋₂, which are shown in greater detail in FIG. 5D. In the exemplary embodiment, each contact plan includes a plan name (e.g., “Plan PA₁₋₁”), context information, a retry count, method information, and an escalation user. The plan name is unique for each contact plan and serves as an identifier for a specific contact plan. The context information allows the reactor 220 to match a contact plan with the context information collected with an alert is initiated. The retry count indicates a number of times to execute the contact plan before escalation. In the case of Plan PA₁₋₁, the contact plan will be executed two times before escalation. The method information includes an ordered list of any number of contact method steps, each step including a name of a contact method, a method timeout that defines how long to wait for confirmation prior to going to the next method step in the contact plan, and a contact method retry count that defines the number of times the contact method step should be retried before going to the next method step in the contact plan. The escalation user defines a user that that AMS should attempt to contact in the event that the present user cannot be contacted.

Alert Notification Processing

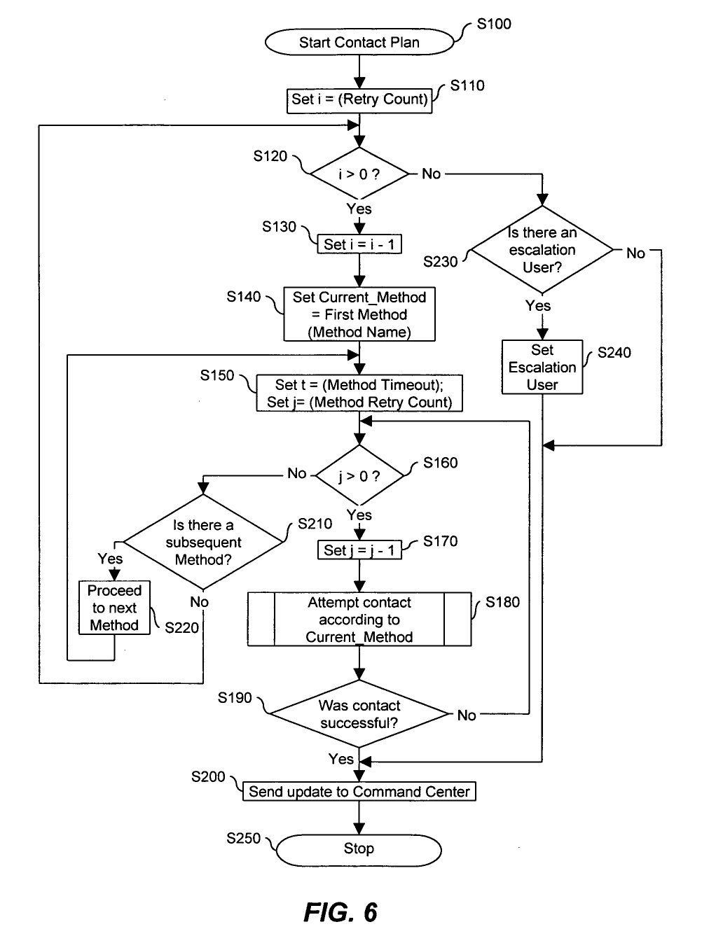

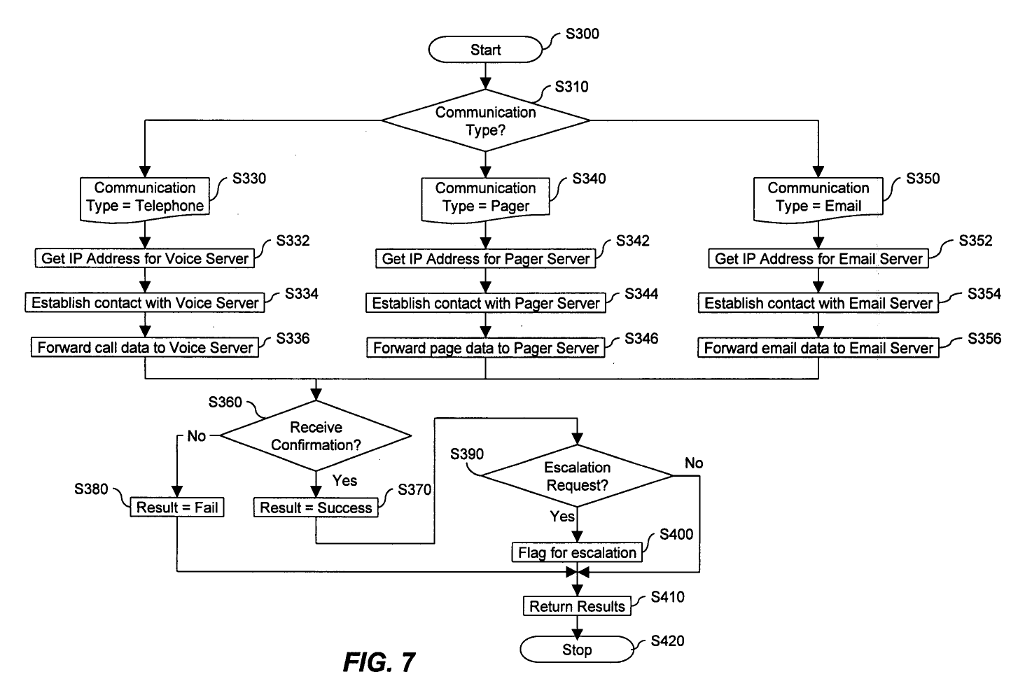

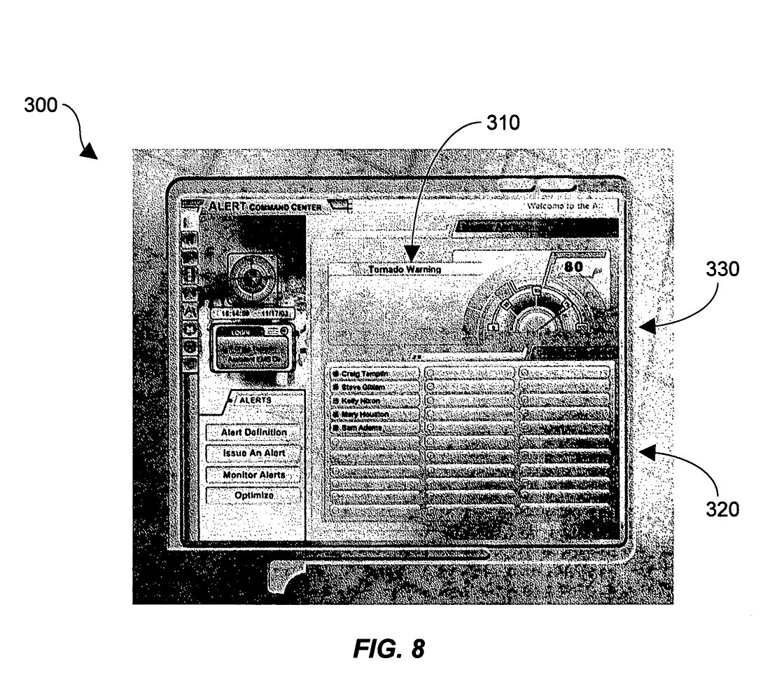

FIG. 6 shows a flow chart illustrating how the AMS, specifically the reactor 220, processes a contact plan. The process begins at step S100. There are a number of ways the processing of a contact plan can be initiated, including a reference to initiate a contact plan in an alert definition or as a result of a previously-executed contact plan being escalated. At step S10, a counter i is set equal to the value in the “Retry Count” field of the contact plan. The counter i is used to keep track of the number of times the contact plan has been performed. Next, at step S120 a check is made to determine if the counter i is greater than zero, which would indicate that the contact plan is to be performed at least one more time, as would normally be the case the first time step S120 is performed in the process. If i>0 (“Yes” at step S120) then the process continues to step S130 where i is decreased by 1 to account for the current pass through the contact plan. Then at step S140 a variable Current_Method is set to the name of the first contact method listed in the present contact plan. For example, if contact plan Plan PA₁₋₁ shown in FIG. 5D were being processed, Current_Method would be set to “Method MA₁₋₁” since it is the first contact method listed in Plan PA₁₋₁. Next, at step S150 a value t is set equal to the Method Timeout for the current contact method (t=5 minutes for Method MA₁₋₁) and a counter j is set equal to the Method Retry Count for the current contact method (j=2 for Method MA₁₋₁). At step S160, a check is made to determine if the counter j is greater than zero, which would normally be the case the first time step S160 is performed for each contact method. If j>0 (“Yes” at step S160) then the process continues to step S170 where j is decreased by 1 to account for the current attempt at using the present contact method. Then, at step S180 a process, shown in FIG. 7 and discussed in greater detail below, is performed for attempting to notify the user according to the present contact method.

At step S190 a determination is made as to whether the user was successfully contacted at step S180. If the user was successfully contacted (“Yes” at step S190) then the process continues to step S200, where the reactor 220 notifies the command center 210 that the user was contacted. The command center 210 can then update the alert monitoring screen at user computer 100. Once the update has been completed, the process stops at step S250.

On the other hand, if at step S190 it is determined that the user was not successfully contacted at step S180 (“No” at step S190), then the process returns to step S160. If at step S160 it is determined that j>0, then steps S170-S190 are repeated for the current contact method. In the case of Plan PA₁₋₁, since Retry Count for Method MA₁₋₁ is equal to two, steps S170-S190 would be repeated in order to make a second attempt to contact User A₁ at their work telephone. If the second attempt is also unsuccessful, the process again returns to step S160, at which point j would equal zero (“No” at step S160) so the process would proceed to step S210. At step S210, a determination is made as to whether there is an contact method in the present contact plan, which would be “Yes” for Plan PA₁₋₁ since there is a second contact method listed after Method MA₁₋₁ named Method MA₁₋₂. In this case, step S210 would proceed to step S220 which shifts the process to the next contact method, Method MA₁₋₂. Then the process returns to step S150, and repeats the steps from step S150 on as described above, except this time the Method MA₁₋₂ is used. Thus, referring to FIGS. 5B and 5D, this time the AMS will attempt to contact User A₁ at their home telephone (Method Name=Method MA₁₋₂=Home Telephone), the time allotted for attempting to contact User A₁ at their home telephone will be limited to five minutes (Method Timeout=5 min.), and only one attempt will be made (Method Retry Count=1).

If at step S210 it is determined that there are no further contact methods in the present contact plan, the process returns to step S120 (e.g., if contact plan PA₁₋₁ has exhausted contact methods MA₁₋₁, MA₁₋₂, and MA₁₋ₙ). At step S120 the counter i is checked again to determine whether i>0. If so, then i is decremented again at step S130, the process returns to the first contact method in the contact plan at step S140 and the process with again attempt to contact the user according to each contact method in the contact plan until the user is reached. In the case of contact plan PA₁₋₁, retry count=2 so a second attempt would be made to contact User A₁ according to the contact plan.

On the other hand, if at step S120 i has reached zero (“No” at step S120), then the process would continue to step S230 (e.g., in the case of Plan PA₁₋₁, if the process has made two passes through the list of contact methods then i=0). At step S230, a determination is made as to whether the present contact plan includes an escalation user (i.e., a person to contact in the event User A₁ cannot be reached). In the case of Plan PA₁₋₁, User A₃ has been designated as the escalation user, so step S230 would result in “Yes” and the process would continue to step S240 where a flag is set indicating that there is an escalation required, and a user name is provided for the escalation. The process then continues to step S200, where the reactor 220 sends an update to the communicator 210 indicating that the contact plan has been completed, the present user has not been contacted, and an escalation will be performed. Once the update has been completed, the process stops at step S250. However, since there is an escalation request, the process will be repeated according to a contact plan for User A₃.

If the present contact plan includes no escalation user (“No” at step S230), then the process skips step S240 and proceeds to step S200, where the reactor 220 sends an update to the communicator 210 indicating that the contact plan has been completed and the present user has not been contacted. Once the update has been completed, the process stops at step S250.

Referring now to FIG. 7, the contact process at step S180 mentioned above will now be discussed. In the exemplary embodiment, the contact process shown in FIG. 7 is performed by the communicator 240 and begins at step S300 upon receiving a request from the reactor 220. At step S310, a determination is made as to what type of communication is associated with the request. Different possible types of communication include telephone at step S330, pager at step S340, and email at step S350.

In the case of telephone communication, at step S332 the communicator 240 retrieves information necessary for establishing contact with the telephone web service at voice server 130. In the exemplary embodiment, step S332 includes retrieving the IP address for the voice server 130 from the database 230. Step S332 can also include retrieving login information for allowing AMS to login to the web service at the voice server 130. Next, at step S334 the communicator 240 establishes contact with the voice server 130, including performing any necessary login routines. At step S336 the communicator 240 forwards telephone call data to the voice server 130. The telephone call data can include such information as a telephone number, a message (e.g., the “long message” included with the context information) to play if the telephone call is answered, and time and/or ring number constraints related to the method timeout value t from step S150 (FIG. 6) for limiting the amount of time the voice server 130 spends waiting for the telephone call to be answered. The telephone call data can also include a pin number or identification code to be entered by the user receiving the telephone call to provide confirmation that the intended person has been notified. The telephone call data can further include instructions for providing the user receiving the telephone call to request further action or escalation, which will be discussed in more detail below.

In the case of pager communication, the communicator 240 performs steps 342, 344, and 346, which are similar to steps 332, 334, and 336, respectively. One notable exception is that the page data of step S346 relates to information for transmitting a message to a pager. The page data can vary for different types of pagers. In some cases, the user might have a pager capable of two-way messaging so that the pager can display a text message or play a voice message, and the user can send a reply confirmation message. In this case, the page data can include time constraints related to the method timeout value t from step S150 (FIG. 6) for limiting the amount of time the pager web service spends waiting for a confirmation message from the user. Otherwise, the user can be required to provide a reply message, for example by telephone or email, within some amount of time before the AMS considers the contact attempt unsuccessful.

In the case of email communication, the communicator 240 performs steps 352, 354, and 356, which are similar to steps 332, 334, and 336, respectively. Again, the notable exception is that the email data of step S356 relates to information for transmitting an email message to a user, such as an email address and time constraints related to the method timeout value t from step S150 (FIG. 6) for limiting the amount of time the email server 140 spends waiting for a confirmation message via reply email.

At step S360, the communicator 240 determines whether a confirmation message has been received. If a confirmation message is received (“Yes” at step S360), then the process continues to step S370 where a result value is set to indicate that the user has been successfully contacted. Otherwise (“No” at step S360), the process continues to step S380 where the result value is set to indicate that the user has not been successfully contacted.

If the user was successfully contacted, the process continues from step S370 to step S390, where the communicator 240 determines whether the user issued an escalation request, discussed below. If the user requested escalation (“Yes” at step S390), then the process continues to step S400 where a flag is set to indicate the presence of an escalation request. Then, at step S410, the results of the contact attempt are passed back to the reactor 220, including whether contact was successful or failed and any escalation requests. The process then stops at step S420.

Alert Monitoring

The AMS provides users with progress reports for ongoing alerts. One way this is done is through a real-time alert monitoring interface. This interface includes an alert name, a listing of users that have been contacted (with or without the status of the contacts), and a progress indicator that includes numerical and/or graphical indications of the percentage of personnel that have been successfully contacted. It is contemplated that other information can be included on an alert monitoring interface, including a listing of users not contacted, current workflow state, initiating user, initiation date and time, and any of the other context information discussed above.

In addition to providing a user with progress information, the alert monitoring interface also allows a user to actively manage the alert in progress. For example, if a monitoring user notices that a certain user has not yet been successfully contacted and the situation is particularly urgent, the monitoring user can instruct the AMS to go ahead and escalate to the escalation user listed for the user that has not been contacted.

The AMS can also provide progress reports using other forms of communication. For example, when a user receives a telephone call from the AMS notifying them of an alert, the user can be presented with the option to check the status condition of the alert. This way, the user can receive alert progress information over the telephone.

Although illustrative embodiments and applications of the present invention are shown and described herein, many variations and modifications are possible which remain within the concept, scope, and spirit of the invention, and these variations would become clear to those of ordinary skill in the art upon review of this description. For example, although the present invention is described within the context of a web service networked to a customer, the present invention is not limited to this arrangement. Rather, it should be understood that the present invention would equally to any arrangement. Thus, the AMS system can be provided locally to an organization, perhaps even residing on a single computer that serves as the user's computer, the alert server, the communication servers, the database server, or any combination thereof. The AMS can be provided for the exclusive use of a single organization that excludes access by any other organizations, or provides access for any number of organizations. Components of the AMS can be rearranged, combined, separated, stored or run on any number of computers, servers, and storage devices of any kind, written in any programming language, and communicate using any form of communication or type of communication protocol. The meaning of an alert can be construed to include any kind of situation where it can be considered desirable to provide information to a person or persons, and thus is not limited to emergency situations. The terms computer and server are merely illustrative and are not intended to be limiting to any particular type of computing or processing device. Accordingly, the present embodiments are to be considered as illustrative and not restrictive, and the invention is not to be limited to the details given herein, but may be modified within the scope and equivalents of the claims without departing from the spirit and scope of the present invention.

What is claimed is:

1. A method of managing an alert comprising steps of:
detecting an initiation of the alert according to a predefined alert definition that includes first and second status conditions and a first-transition subscriber that subscribes to a transition between the first and second status conditions;
transitioning the alert from the first status condition to the second status condition; and
attempting to deliver a notification of the transition from first to second status condition to the first-transition subscriber according to a contact plan associated with the first-transition subscriber.

2. A method according to claim 1, further comprising a step of providing a progress report indicating whether the first-transition subscriber has received the notification.

3. A method according to claim 1, wherein the predefined alert definition includes an alert workflow stipulating that the alert includes a plurality of status conditions including the first and second status conditions.

4. A method according to claim 3, wherein the plurality of status conditions includes at least one of a pending status condition, an active status condition, and a cancelled status condition.

5. A method according to claim 1, further comprising a step of retrieving context information related to the initiation of the alert.

6. A method according to claim 5, wherein the context information includes at least one of a time of alert initiation, an alert-initiating user, a severity, a location, a priority, a message, and an expiration time.

7. A method according to claim 5, wherein the step of attempting to deliver the notification is performed according to a selected one of a plurality of contact plans associated with the first-transition subscriber.

8. A method according to claim 7, wherein each contact plan includes one or more methods of contacting the first-transition subscriber.

9. A method according to claim 8, wherein the step of attempting to deliver the notification includes selecting the contact plan based on the retrieved context information.

10. A method according to claim 9, wherein the step of attempting to deliver the notification includes attempting to contact the first-transition subscriber using each of the one or more methods included in the contact plan in a predetermined order until the notification has been delivered.

11. A method according to claim 1, further comprising a step of requesting a transition confirmation prior to transitioning the alert from the first status condition to the second status condition.

12. A method according to claim 11, wherein the step of transitioning the alert from the first status condition to the second status condition is performed only if the transition confirmation is received.

13. A method according to claim 1, wherein the step of attempting to deliver the notification includes halting, if a predetermined point in the contact plan is reached, attempts to contact the first-transition subscriber and proceeding to attempt to contact an escalation user designated by the contact plan.

14. A method according to claim 1, further comprising a step of requesting that the first-transition subscriber provide confirmation feedback confirming that the first-transition subscriber has received the notification.

15. A method according to claim 1, further comprising a step of requesting whether the first-transition subscriber would like to initiate another alert.

16. A method of managing an alert comprising steps of:
detecting an initiation of the alert according to a predefined alert definition that includes a designated subscriber;
retrieving context information related to the initiation of the alert;
determining whether the designated subscriber should be notified of the alert based on the retrieved context information; and
attempting to deliver a notification of the alert to the designated subscriber only if it is determined that the designated subscriber should be notified.

17. A method according to claim 16, wherein the context information includes at least one of a time of alert initiation, an alert-initiating user, a severity, a location, a priority, a message, and an expiration time.

18. A method according to claim 16, wherein the step of attempting to deliver the notification includes a step of selecting one of a plurality of contact plans for contacting the designated subscriber based on the retrieved context information.

19. A method of managing an alert comprising steps of:
detecting an initiation of the alert according to a predefined alert definition that includes a designated subscriber;
retrieving context information related to the initiation of the alert;
selecting one of a plurality of contact plans for contacting the designated subscriber based on the retrieved context information; and
attempting to deliver a notification of the alert to the designated subscriber based on the selected contact plan.

20. A method according to claim 19, wherein each of the plurality of contact plans includes one or more methods of contacting the designated subscriber.

21. A method according to claim 20, wherein the step of attempting to deliver the notification includes attempting to contact the designated subscriber using each of the one or more methods included in the selected contact plan in a predetermined order until the notification has been delivered.

22. An alert management apparatus comprising:
a processing component for detecting an initiation of the alert according to a predefined alert definition that includes first and second status conditions and a first-transition subscriber that subscribes to a transition between the first and second status conditions, and for transitioning the alert from the first status condition to the second status condition; and
a communication component for attempting to deliver a notification of the transition from first to second status condition to the first-transition subscriber according to a contact plan associated with the first-transition subscriber.

23. An apparatus according to claim 22, further comprising an interface component for providing a progress report indicating whether the first-transition subscriber has received the notification.

24. An apparatus according to claim 22, wherein the predefined alert definition includes an alert workflow stipulating that the alert includes a plurality of status conditions including the first and second status conditions.

25. An apparatus according to claim 24, wherein the plurality of status conditions includes at least one of a pending status condition, an active status condition, and a cancelled status condition.

26. An apparatus according to claim 22, wherein the processing component retrieves context information related to the initiation of the alert.

27. An apparatus according to claim 26, wherein the context information includes at least one of a time of alert initiation, an alert-initiating user, a severity, a location, a priority, a message, and an expiration time.

28. An apparatus according to claim 26, wherein the communications component attempts to deliver the notification according to a selected one of a plurality of contact plans associated with the first-transition subscriber.

29. An apparatus according to claim 28, wherein each contact plan includes one or more methods of contacting the first-transition subscriber.

30. An apparatus according to claim 29, wherein the processing component selects the contact plan based on the retrieved context information.

31. An apparatus according to claim 30, wherein the communications component attempts to contact the first-transition subscriber using each of the one or more methods included in the contact plan in a predetermined order until the notification has been delivered.

32. An apparatus according to claim 22, wherein the processing component controls one of the interfacing component and the communications component to request a transition confirmation for transitioning the alert from the first status condition to the second status condition.

33. An apparatus according to claim 32, wherein the processing component is configured to transition the alert from the first status condition to the second status condition only if the transition confirmation is received.

34. An apparatus according to claim 22, wherein if a predetermined point in the contact plan is reached, the processing component controls the communications component to halt attempts to contact the first-transition subscriber and to proceed with attempting to contact an escalation user designated by the contact plan.

35. An apparatus according to claim 22, wherein the communications component requests that the first-transition subscriber provide confirmation feedback confirming that the first-transition subscriber has received the notification.

36. An apparatus according to claim 22, wherein the communications component requests the first-transition subscriber to indicate whether initiation of another alert is desired.

37. An apparatus for managing an alert comprising:
a processing component for detecting an initiation of the alert according to a predefined alert definition that includes a designated subscriber, retrieving context information related to the initiation of the alert, and determining whether the designated subscriber should be notified of the alert based on the retrieved context information; and
a communications component for attempting to deliver a notification of the alert to the designated subscriber only if it is determined that the designated subscriber should be notified.

38. An apparatus according to claim 37, wherein the context information includes at least one of a time of alert initiation, an alert-initiating user, a severity, a location, a priority, a message, and an expiration time.

39. An apparatus according to claim 37, wherein the processing component selects one of a plurality of contact plans for contacting the designated subscriber based on the retrieved context information.

40. An apparatus for managing an alert comprising:
a processing component for detecting an initiation of the alert according to a predefined alert definition that includes a designated subscriber, retrieving context information related to the initiation of the alert, and selecting one of a plurality of contact plans for contacting the designated subscriber based on the retrieved context information; and
a communications component for attempting to deliver a notification of the alert to the designated subscriber based on the selected contact plan.

41. An apparatus according to claim 40, wherein each of the plurality of contact plans includes one or more methods of contacting the designated subscriber.

42. An apparatus according to claim 41, wherein the communications component attempts to contact the designated subscriber using each of the one or more methods included in the selected contact plan in a predetermined order until the notification has been delivered.

43. A computer-readable medium having computer-executable instructions for performing steps comprising:
detecting an initiation of the alert according to a predefined alert definition that includes first and second status conditions and a first-transition subscriber that subscribes to a transition between the first and second status conditions;
transitioning the alert from the first status condition to the second status condition; and
attempting to deliver a notification of the transition from first to second status condition to the first-transition subscriber according to a contact plan associated with the first-transition subscriber.

44. A computer-readable medium according to claim 43 having further computer-executable instructions for performing a step of providing a progress report indicating whether the first-transition subscriber has received the notification.

45. A computer-readable medium according to claim 43, wherein the predefined alert definition includes an alert workflow stipulating that the alert includes a plurality of status conditions including the first and second status conditions.

46. A computer-readable medium according to claim 45, wherein the plurality of status conditions includes at least one of a pending status condition, an active status condition, and a cancelled status condition.

47. A computer-readable medium according to claim 43 having further computer-executable instructions for performing a step of retrieving context information related to the initiation of the alert.

48. A computer-readable medium according to claim 47, wherein the context information includes at least one of a time of alert initiation, an alert-initiating user, a severity, a location, a priority, a message, and an expiration time.

49. A computer-readable medium according to claim 47, wherein the step of attempting to deliver the notification is performed according to a selected one of a plurality of contact plans associated with the first-transition subscriber.

50. A computer-readable medium according to claim 49, wherein each contact plan includes one or more methods of contacting the first-transition subscriber.

51. A computer-readable medium according to claim 50, wherein the step of attempting to deliver the notification includes selecting the contact plan based on the retrieved context information.

52. A computer-readable medium according to claim 51, wherein the step of attempting to deliver the notification includes attempting to contact the first-transition subscriber using each of the one or more methods included in the contact plan in a predetermined order until the notification has been delivered.

53. A computer-readable medium according to claim 43 having further computer-executable instructions for performing a step of requesting a transition confirmation prior to transitioning the alert from the first status condition to the second status condition.

54. A computer-readable medium according to claim 53, wherein the step of transitioning the alert from the first status condition to the second status condition is performed only if the transition confirmation is received.

55. A computer-readable medium according to claim 43, wherein the step of attempting to deliver the notification includes halting, if a predetermined point in the contact plan is reached, attempts to contact the first-transition subscriber and proceeding to attempt to contact an escalation user designated by the contact plan.

56. A computer-readable medium according to claim 43 having further computer-executable instructions for performing a step of requesting that the first-transition subscriber provide confirmation feedback confirming that the first-transition subscriber has received the notification.

57. A computer-readable medium according to claim 43 having further computer-executable instructions for performing a step of requesting whether the first-transition subscriber would like to initiate another alert.

58. A computer-readable medium having computer-executable instructions for performing steps comprising:
detecting an initiation of the alert according to a predefined alert definition that includes a designated subscriber;
retrieving context information related to the initiation of the alert;
determining whether the designated subscriber should be notified of the alert based on the retrieved context information; and
attempting to deliver a notification of the alert to the designated subscriber only if it is determined that the designated subscriber should be notified.

59. A computer-readable medium according to claim 58, wherein the context information includes at least one of a time of alert initiation, an alert-initiating user, a severity, a location, a priority, a message, and an expiration time.

60. A computer-readable medium according to claim 58, wherein the step of attempting to deliver the notification includes a step of selecting one of a plurality of contact plans for contacting the designated subscriber based on the retrieved context information.

61. A computer-readable medium having computer-executable instructions for performing steps comprising:
detecting an initiation of the alert according to a predefined alert definition that includes a designated subscriber;
retrieving context information related to the initiation of the alert;
selecting one of a plurality of contact plans for contacting the designated subscriber based on the retrieved context information; and
attempting to deliver a notification of the alert to the designated subscriber based on the selected contact plan.

62. A computer-readable medium according to claim 61, wherein each of the plurality of contact plans includes one or more methods of contacting the designated subscriber.

63. A computer-readable medium according to claim 62, wherein the step of attempting to deliver the notification includes attempting to contact the designated subscriber using each of the one or more methods included in the selected contact plan in a predetermined order until the notification has been delivered.

64. A method comprising steps of:
subscribing to a predefined alert;
creating a plurality of contact plans for receiving an alert notification, each contact plan including different context information; and
receiving, according to a selected contact plan of the plurality of contact plans, the alert notification,
wherein said selected contact plan is selected based on the context information included in the selected contact plan.

65. A method according to claim 64, further comprising a step of receiving a progress report indicating whether another subscriber has received the alert notification.

66. A method according to claim 64, wherein the step of subscribing to the alert definition includes designating a transition in the predefined alert, wherein the alert notification indicates that said transition in the predefined alert has occurred.

67. A method according to claim 66, wherein the context information includes at least one of a time of alert initiation, an alert-initiating user, a severity, a location, a priority, a message, and an expiration time.

68. An apparatus according to claim 64, wherein each contact plan includes one or more methods of receiving the alert notification.
